(19) United States
(12) Patent Application Publication
(10) Pub. No.: US 2004/0212205 A1
(43) Pub. Date: Oct. 28, 2004

(54) Method and apparatus for handling semiconductor wafers and interleafs

(76) Inventors: Frank V. Linker II, Springfield, PA (US); Frank V. Linker JR., Broomall, PA (US)

Correspondence Address: Eugene E. Renz, Jr., P.C., 205 North Monroe Street, Post Office Box 2056, Media, PA, 19063-9056, US

(21) Appl. No.: 10/764,785

(22) Filed: Jan. 26, 2004

Related U.S. Application Data
(60) Provisional application No. 60/444,169, filed on Jan. 30, 2003.

(51) Int. Cl. B25J 15/06

(52) U.S. Cl. 294/64.1

(57) ABSTRACT

A vacuum pickup device for handling semiconductor wafers and interleaf separators comprising a generally flat paddle member having a pickup surface and a planar top surface, a means for drawing air through an orifice in the paddle which creates a first vacuum of a predetermined magnitude on the pickup surface and directing the air over the top surface thereby creating an additional second vacuum at the periphery of the paddle to provide an additional lifting force gently supporting the wafer on the pickup surface whereby a low vacuum is distributed over a wide area to provide a good uniform gentle more even lifting force.

### CROSS REFERENCE TO RELATED APPLICATION

This application claims the benefit of U.S. Provisional Application No. 60/444,169 entitled AERO-FLO PICKUP TOOL filed Jan. 30, 2003.

### BACKGROUND OF THE INVENTION

1. Technical Field

The present invention relates to improvements in method and apparatus for handling electronic work pieces such as semiconductor wafers.

2. Description of Related Art

Semiconductor wafers are extremely fragile and typically have a thickness of about 0.025 inches or less. These wafers are generally flat disc shape and have a circuit chip on one face thereof. Typically these wafers are stacked in so-called jars for transportation from one location to another and disc-shaped interleafs are usually placed between the wafers to separate the wafer surfaces from contacting one another during shipment. The interleafs are made of a variety of materials and in many instances are made of a porous materials, such as tyvek and foam.

Methods and apparatus for handling semiconductor wafers and interleafs are not new per se. Example a prior art vacuum actuated tool for handling semiconductor wafers is shown in U.S. Pat. No. 5,217,273, issued Jun. 8, 1993, entitled, SERIAL PUMPING FOR PORTABLE HANDLING TOOL OF ELECTRONIC WORKPIECES. The tool as illustrated has a vacuum tip (12) having a stem (18) for engaging in a fitting (20) connected to a vacuum source. Air is evacuated from the chamber (22) via an opening (24) in the vacuum tip. This tool system as set forth in the patent require a vacuum pressure in the range of 21 to 22 inches of Hg. It has been found that this low flow and high vacuum method and tool are generally acceptable for handling standard 0.010-0.025 inch thickness wafers. However, handling wafers below 0.008 inches in thickness creates a problem at these higher vacuums including breakage, bowing and distortion. This is due to the fact that the channel feeding the vacuum must be reduced to prevent distortion and damaging the thinner and more flexible wafers. Further, reducing the channel may prevent flexing but also reduces the effective holding area. Thus the tool is less effective for securely holding the wafers.

SPI/semicon markets a pickup paddle generally similar in shape and operation to the tools shown in the Hendricsen, '273 patent utilizing in-house vacuum systems at wafer fabrication facilities. Utilization of in-house vacuum systems introduces concerns over particulate generation.

In summary, the prior art systems which are high-vacuum, low-flow systems have certain disadvantages and drawbacks including cost, generation of unwanted particulate matter and damage to the very thin semiconductor wafers which are becoming state of the art.

### SUMMARY OF THE INVENTION

With the foregoing in mind, it is an object of the present invention to provide an improved vacuum pickup device characterized by novel features of construction and arrangement to facilitate handling of standard as well as ultra thin semiconductor wafers, thin bowed wafers and interleafs of various sizes and materials. To this end, the tool comprises a generally flat paddle having a wafer pickup surface and an opposing top surface, an orifice in the paddle and means for drawing air through the orifice and the paddle to create a first vacuum of a predetermined magnitude on the pickup surface and directing a stream of air over the top surface. The air distribution over the top surface creates an additional second vacuum in the region of the periphery of the paddle which in turn provides an additional lifting force gently supporting the wafer on the pickup surface. This flow arrangement essentially distributes a low vacuum over a wide area to provide a good and more even lifting force supporting a wafer on the pickup surface of the paddle.

More specifically, the device utilizes an electrically empowered impeller positioned above the top surface of the paddle to draw air in through the orifice in the paddle and create the primary vacuum on the pickup surface. The impeller then distributes direct air over the top surface which creates a second vacuum zone at the periphery of the paddle to provide the force necessary to support the wafer over its entire face. The impeller is housed in a chamber of the housing having a downwardly and outwardly flared sidewall to direct the exhaust flow over the top face of the paddle in the manner described above.

In addition to the pickup capability, the tool or device of the present invention does not require expensive facility generated vacuum systems since vacuum is generated by the hand tool electrically driving the impeller. The pickup tool of the present invention relies on high flow, low vacuum in the order of 0.5 to 3 inches of Hg over a large area to achieve a sufficient and distributed force holding the wafer or interleaf on the pickup face of the paddle. This arrangement provides lift over a large area by the action of the impeller drawing air in through an orifice pattern and exhausting the air over the flat top surface of the pickup paddle as shown by the arrow designated in FIGS. 3 and 4. The holding force of the tool of the present invention is generally the equivalent of other systems utilizing high vacuum over a small area without the harmful effects of high vacuum systems on thin fragile wafers. The exhausting air creates additional negative pressure at the outside edges of the pickup paddle. Specifically, it is observed that the air flow over the top face as it flows past the peripheral edge of the paddle creates a phenomenon comparable to an air vortex in this region producing an additional or supplemental negative pressure zone enhancing the suction force holding a wafer. The prior art systems do not teach or suggest circulating air in the fashion to produce the beneficial effects described. The use of both the intake and exhausting air produces a very efficient pickup tool.

### DESCRIPTION OF THE DRAWINGS

These and other objects of the present invention and the various features and details of the operation and construction thereof are hereinafter more fully set forth with reference to the accompanying drawings wherein;

FIG. 1 is a perspective view showing the tool in position to withdraw a wafer from a cassette;

FIG. 2 is a perspective view showing the tool discharging a wafer into a jar;

FIG. 3 is a transverse sectional view showing the internal components of the tool;

FIG. 3A is a fragmentary enlarge sectional view showing the details of the impeller mounting;

FIG. 4 is a schematic side elevational view showing the pattern of vacuum area across the pickup face of the paddle;

FIG. 5 is a view showing the packaging of wafers and interleafs in a shipping container or jar;

FIG. 6 is a view similar to FIG. 5 showing the effect on lifting an interleaf when the air flow over the top face of the paddle is interrupted, thus negating the secondary vacuum;

FIG. 6A is a view similar to FIG. 6 showing the pattern of the air flow when air flow over the top face of the paddle is interrupted;

FIG. 7 is a perspective view of the tool and various forms of paddle;

FIG. 7A is a cross sectional view of pickup paddle with a wafer in a vacuum seated state;

FIG. 7B is a bottom view of paddle with shaded air channels;

FIG. 8 is a perspective showing a pickup paddle with a top mounted guide to align the paddle parallel with the wafer by using a geometrical feature of the cassette; and

FIG. 9 is an end elevational view showing the position of the paddle when using the top mounted guide.

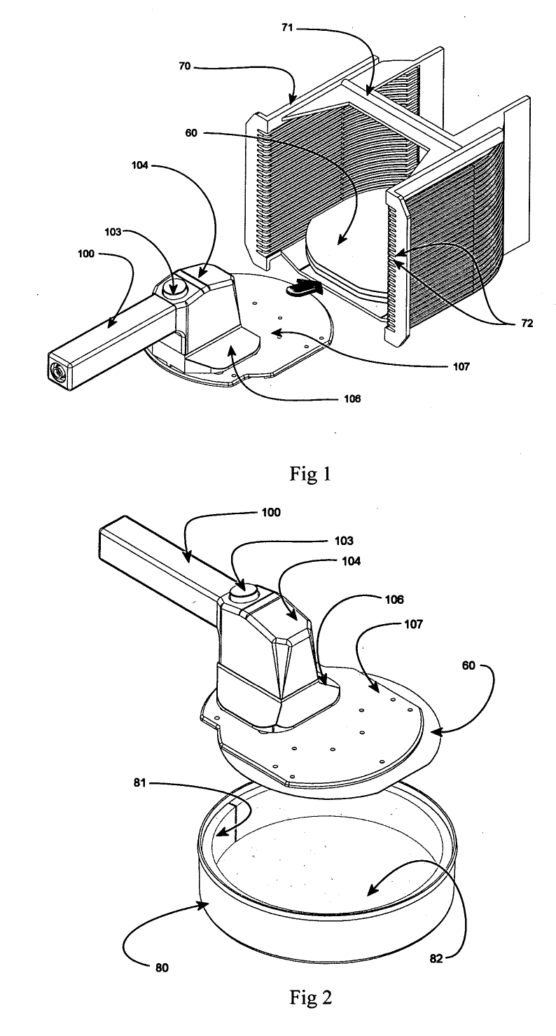

### DESCRIPTION OF THE PREFERRED EMBODIMENTS

The tool of the present invention is used to load and unload wafers (60) in typical cassettes (70) and jars (80). Wafers (60) typically are disc shaped thin silicon elements having electronic circuits on one face and the interleafs (50) are paper or plastic discs used between wafers (60) in packaging to prevent contact between wafers. As illustrated, wafer cassettes (70) are utilized to transfer wafers through various manufacturing processes and have a plurality of slots (72) to house a predetermined number of wafers (60) generally equally spaced at a pitch. Wafer jars (80) are containers used for shipping wafers. Some jars include a foam liner (81) and foam bottom pad (82) to provide safe support for the wafers during shipment.

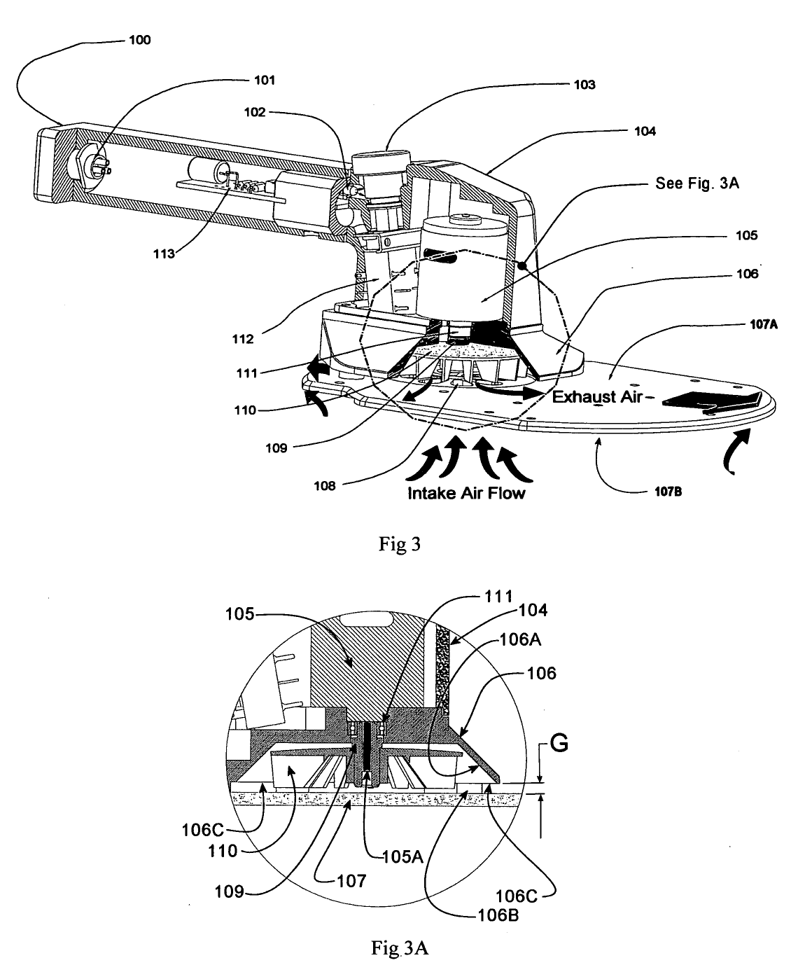

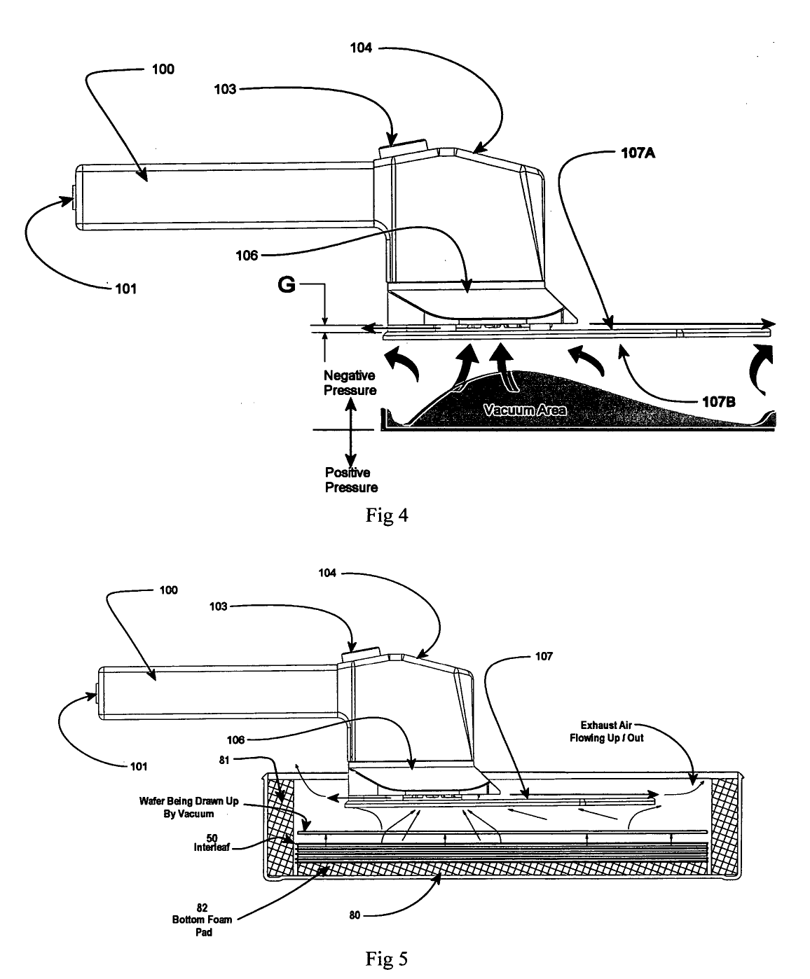

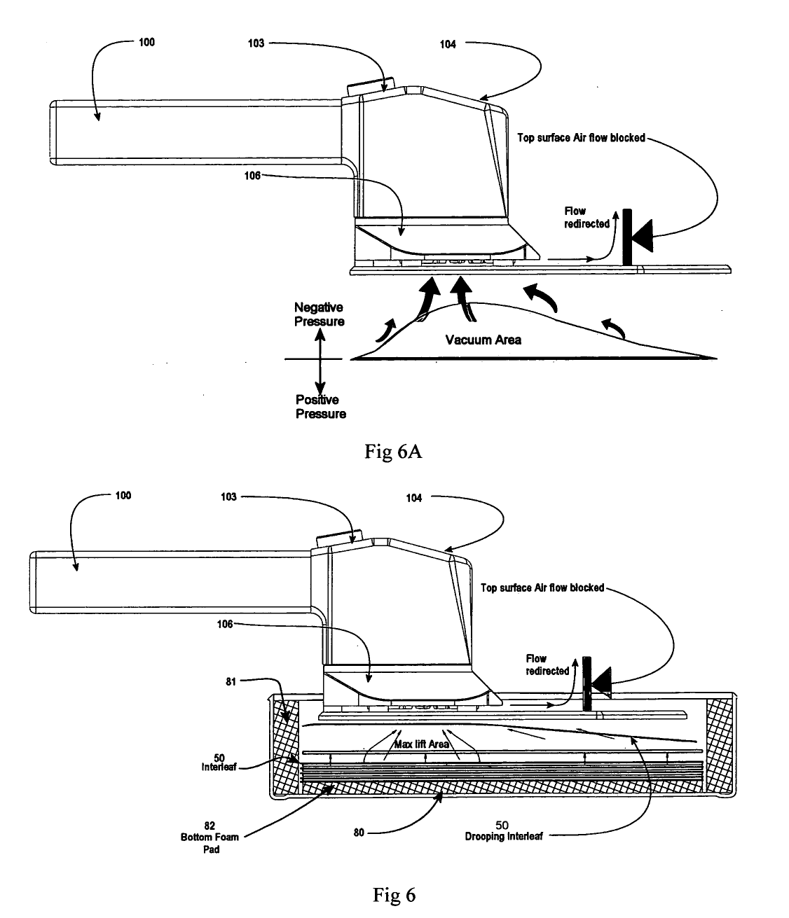

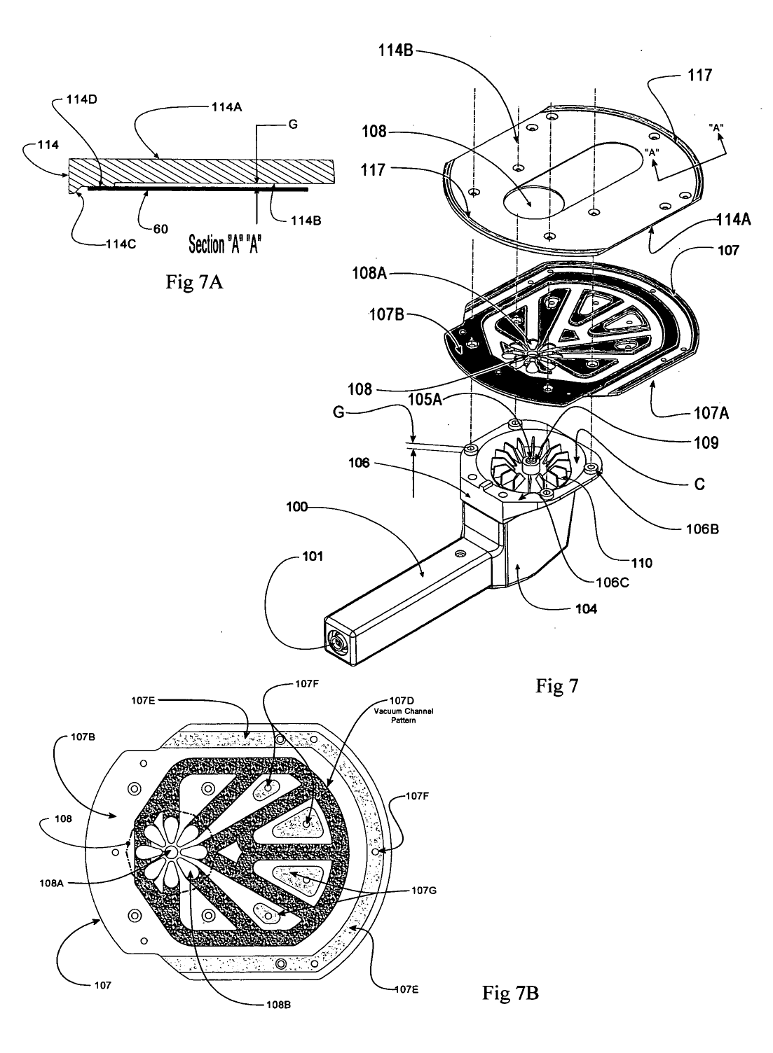

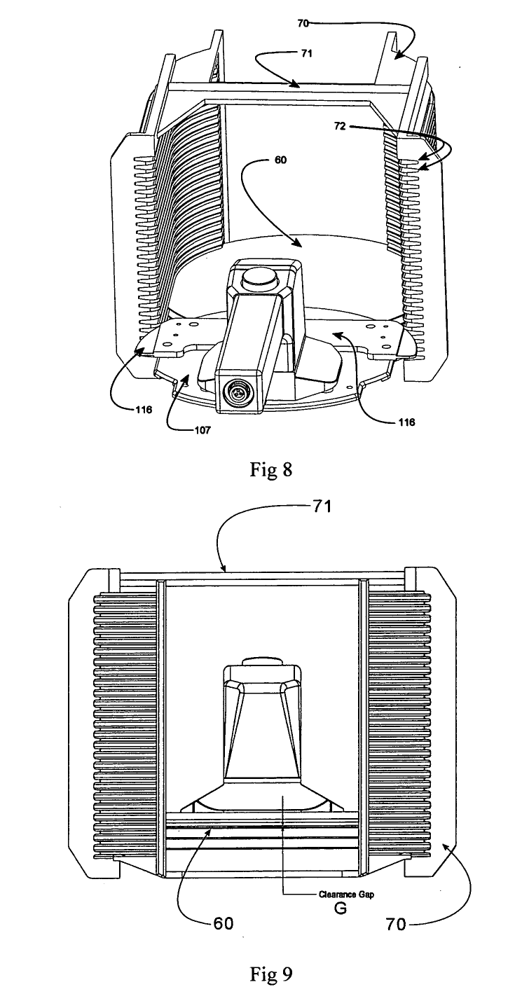

Referring now to the drawings and particularly to FIGS. 3 and 7 thereof, there is shown a device or tool for picking up semiconductor wafers (60) and/or interleafs (50) in accordance with the present invention. The tool as illustrated comprises of elongated generally hollow housing (104) having a handle portion (100) projecting outwardly from the housing adjacent the upper end thereof. A motor base mount (106) extends from the housing (104) and supports a motor (105). The motor (105) is supported on the top wall of the motor base mount (106). The drive shaft (105a) of the motor (105) mounts to motor coupling (109) which extends down through a radial bearing (111). The motor coupling portion extending below the radial bearing (111) connects the drive shaft (105a) to a fan impeller (110). The compartment (C) in the motor base mount (106) for the fan impelling (110) has a downwardly and outwardly flared circumferentially extending surface (106a) for directing air flow over the top face of the paddle (107) in a predetermined manner described in more detail below.

The tool further comprises a paddle (107) having a lower pickup surface or face (107b) a generally planar top surface or face (107a). The paddle has an intake orifice (108) in the present instance of a daisy pattern consisting of a circular opening (108a) in the center and petal shaped opening configuration (108b) extending radially in a circular array from the center circular opening (108a). The motor base mount (106) is secured to the top face (107a) of the paddle and spaced in such a manner to define a space or gap (G) between the top face (107a) and the lower edge of the motor base mount (106) whereby air drawn in and over the lower pickup face (107b) by the impeller (110) and then exhausted over the top face (107a) of the paddle in a manner described in more detail hereafter. In the present instance, the motor base mount (106) has a series of pads or feet (106b) projecting from the bottom face or surface (106c) so that when the motor base mount (106) is secured in place on the paddle (107), the impeller (110) overlies the paddle intake orifices (108) and the bottom lower surface (106c) of the motor mount (106) is spaced upwardly from the top face (107a) of the paddle to define the gap (G) for circulating the exhaust air over the top face and create the second vacuum zone adjacent the periphery of the paddle.

In accordance with the principal embodiment of paddle in accordance with the present invention shown in FIG. 7B, the pickup face (107b) is of a geometric configuration defining a number of passageways or channels (107d) emanating from the paddle intake orifice (108) which funnel air to the primary vacuum zone to define a large lift area on the lift surface (107b). Further, a generally U-shaped trackway (107e) is provided on three sides of the paddle which are open to the environment to admit ambient air to facilitate release of the wafer (60) or interleaf (50). The pickup face (107b) has a number of pockets (107g) in the generally triangular patterns defined by the channels (107d) which have through holes (107f). By this arrangement when the vacuum is released, the ambient air enters the vacuum channels to produce quick release of wafers and interleafs. Through holes (107f) are provided in the paddle to facilitate release of the wafer when the faces are wet as a result of a manufacturing process, such as grinding.

There is shown in FIGS. 7 and 7A a modified form of paddle in accordance with the present invention. In this instance, the paddle (114) is of a configuration to embrace a wafer (60) and is of a predetermined size and shape to accommodate a given sized wafer (60). Thus, the paddle has spaced parallel side edges and arcuate upstanding ribs (117) at opposing ends which project upwardly from the pickup face (114b) of the paddle. The ribs (117) as illustrated have an inwardly tapered face (114c) and a lateral ledge (114d) spaced upwardly from the pickup face (114b). The tapered face (114c) serves as a pilot portion guiding a wafer (60) to the fully seated position engaging the ledge (114d) and spaced by a small gap between the wafer (60) and pickup face (114b).

In the embodiment illustrated, the device is battery powered and the circuit includes a power input receptacle (101), a low voltage input detection circuit (113), a low battery indicator (102) and a power on/off switch (112) and push button actuator (103). Thus, the device is completely portable and does not depend on an appliance outlet for power.

In summary, the present invention is an improvement over prior art systems by reason of the construction and arrangement of the air flow system to provide a reliable lifting force for handling wafers and interleafs. More specifically, it is observed that the air flow over the top face as it flows past the peripheral edge of the paddle creates a phenomenon comparable to an air vortex in this region producing an additional or supplemental negative pressure zone enhancing the suction force holding a wafer. The prior art systems do not teach or suggest circulating air in the fashion to produce the beneficial effects described. The use of both the intake and exhausting air produces a very efficient pickup tool.

Even though particular embodiments of the present invention are shown and described herein, it is not intended to limit the invention and changes and modifications may be made herein within the scope of the followings claims.

What is claimed is:

1. A vacuum pickup device for handling semiconductor wafers and interleaf separators comprising
1) a generally flat paddle member having a pickup surface and a planar top surface,
2) means for drawing air through an orifice in the paddle which creates a first vacuum of a predetermined magnitude on the pickup surface and directing the air over the top surface thereby creating an additional second vacuum at the periphery of the paddle to provide an additional lifting force gently supporting the wafer on the pickup surface whereby a low vacuum is distributed over a wide area to provide a good uniform gentle more even lifting force.

2. A vacuum pickup device as claimed in claim 1 wherein the pickup surface includes a pattern of grooves defining vacuum channels in the pickup face of the paddle.

3. A vacuum pickup device as claimed in claim 1 including a U-shaped vacuum channel formed in the pickup face adjacent the outer periphery thereof having open ends to admitting ambient air when the impeller is deactivated to release a wafer or interleaf.

4. A vacuum pickup device as claimed in claim 1 including a housing for a motor to selectively activate an impeller disposed in a compartment of the housing, said housing having at least a portion spaced upwardly from the top face of the paddle so that air drawn through the orifice in the paddle is directed through the gap to discharge over the top surface of the paddle creating the second vacuum at the periphery of the paddle.

5. A vacuum pickup device as claimed in claim 5 wherein the compartment for the impeller has a downwardly and outwardly flared peripheral side wall which directs flow of incoming air through the gap and over the top face of the paddle.

6. A method of handling wafer and interleafs with a tool having a pickup surface and a top surface consisting of the steps of:
1) creating a low vacuum on the pick up surface of the tool producing a first force for lifting a wafer;
2) simultaneously creating air flow over the top surface producing a second lifting force in the region periphery of the top surface.
